(19) United States
(12) Patent Application Publication
(10) Pub. No.: US 2013/0065587 A1
(43) Pub. Date: Mar. 14, 2013

(54) TERMINAL AND METHOD FOR SUPPORTING MULTIPLE INTERFACES USING USER MOTION

(71) Applicant: Sung Jin HONG, Seoul (KR)

(72) Inventor: Sung Jin HONG, Seoul (KR)

(73) Assignee: PANTECH CO., LTD., Seoul (KR)

(21) Appl. No.: 13/604,515

(22) Filed: Sep. 5, 2012

(30) Foreign Application Priority Data
Sep. 9, 2011 (KR) 10-2011-0091900

(51) Int. Cl. H04W 88/06; H04W 60/00

(52) U.S. Cl. 455/435.2; 455/552.1

(57) ABSTRACT

A method for providing an interface corresponding to a system mode includes detecting a first motion of a terminal, determining whether the first motion is a recognized motion, identifying the system mode corresponding to the recognized motion, searching for a service network supporting the system mode, and providing the interface corresponding to the system mode. A terminal to provide an interface corresponding to a system mode includes a motion recognizing unit to detect a first motion of the terminal, to determine whether the first motion is a recognized motion, and to identify a system mode corresponding to the recognized motion; a searching unit to identify a service network supporting the system mode; and a user interface (UI) processing unit to provide an interface that corresponds to the system mode.

### CROSS-REFERENCE TO RELATED APPLICATION

This application claims priority from and the benefit of Korean Patent Application No. 10-2011-0091900, filed on Sep. 9, 2011, which is hereby incorporated by reference for all purposes as if fully set forth herein.

### BACKGROUND

1. Field

The following description relates to an apparatus and a method for registering a terminal in a service network supporting a system mode associated with a recognized motion, and supporting an interface associated with a service provided in the service network in which the terminal is registered.

2. Discussion of the Background

Generally, a terminal in which multiple subscriber identification modules (SIMs) can be installed may be used to accommodate a roaming service provided in accordance with a roaming contract with other communication service providers in a region where heterogeneous networks may be mixed. The multi-mode terminal may provide a service by installing a SIM corresponding to a Global System for Mobile Communications (GSM) or a Code Division Multiple Access (CDMA). In addition to the multi-mode terminal, a global mode terminal may also provide a mobile communication service through a system mode change.

A system mode change in a general terminal may be performed using a method for manually setting a system mode, which may be performed by requesting information about a mobile communication system from a user. Further, the system mode change in the terminal may be performed using a method for automatically providing a combination of available system modes based on the installed SIMs and enabling the user to select a system mode from the plurality of system modes that may be available, at a time of initial boot. If the foregoing methods are used, the user who may be unfamiliar with technical knowledge about communications may receive unnecessary requests and may experience an inconvenience caused thereby.

### SUMMARY

Exemplary embodiments of the present invention provide an apparatus and a method for registering a terminal in a service network supporting a system mode associated with a recognized motion, and supporting an interface associated with a service provided in the service network in which the terminal is registered.

Additional features of the invention will be set forth in the description which follows, and in part will be apparent from the description, or may be learned by practice of the invention.

Exemplary embodiments of the present invention provide a method for providing an interface corresponding to a system mode including detecting a first motion of a terminal, determining whether the first motion is a recognized motion, identifying the system mode corresponding to the recognized motion, searching for a service network supporting the system mode, and providing the interface corresponding to the system mode.

Exemplary embodiments of the present invention provide a terminal to provide an interface corresponding to a system mode including a motion recognizing unit to detect a first motion of the terminal, to determine whether the first motion is a recognized motion, and to identify a system mode corresponding to the recognized motion; a searching unit to identify a service network supporting the system mode; and a user interface (UI) processing unit to provide an interface that corresponds to the system mode.

Exemplary embodiments of the present invention provide a method for providing an interface corresponding to a system mode including detecting a first position of a terminal, detecting a second position of a terminal, determining whether a movement of the terminal from the first position to the second position is a recognized motion; identifying the system mode corresponding to the recognized motion; searching for a service network supporting the system mode; and providing the interface corresponding to the system mode, in which the movement of the terminal is determined to be the recognized motion if an angle formed between the first position and the second position is at least a reference angle.

It is to be understood that both the foregoing general description and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a diagram illustrating a system supporting multiple interfaces using a user motion according to an exemplary embodiment of the invention.

FIG. 2 is a block diagram illustrating a terminal to support multiple interfaces using a user motion according to an exemplary embodiment of the invention.

FIG. 3 is a diagram illustrating a method for recognizing a motion in a terminal to support multiple interfaces using a user motion according to an exemplary embodiment of the invention.

FIG. 4 is a diagram illustrating a method for recognizing a motion in a terminal supporting multiple interfaces using a user motion according to an exemplary embodiment of the invention.

FIG. 5 is a flowchart illustrating a method for supporting multiple interfaces using a user motion according to an exemplary embodiment of the invention.

FIG. 6 is a diagram illustrating an interface being replaced in accordance with a service change according to an exemplary embodiment of the invention.

FIG. 7 is a flowchart illustrating a method for supporting multiple interfaces using a user motion according to an exemplary embodiment of the invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. It will be understood that for the purposes of this disclosure, “at least one of X, Y, and Z” can be construed as X only, Y only, Z only, or any combination of two or more items X, Y, and Z (e.g., XYZ, XZ, XYY, YZ, ZZ). Throughout the drawings and the detailed description, unless otherwise described, the same drawing reference numerals are understood to refer to the same elements, features, and structures. The relative size and depiction of these elements may be exaggerated for clarity.

It will be understood that if an element is referred to as being “connected to” another element, it can be directly connected to the other element, or intervening elements may be present.

An interface referred to in the present disclosure may include at least one of a small picture, sign, and the like. The interface may be displayed on a display so that an application installed in a terminal may be recognized. Herein, the interface may refer, more particularly, to one or more graphic factors that may be displayed selectively on a display in relation to a program corresponding to a service changed based on motion recognition.

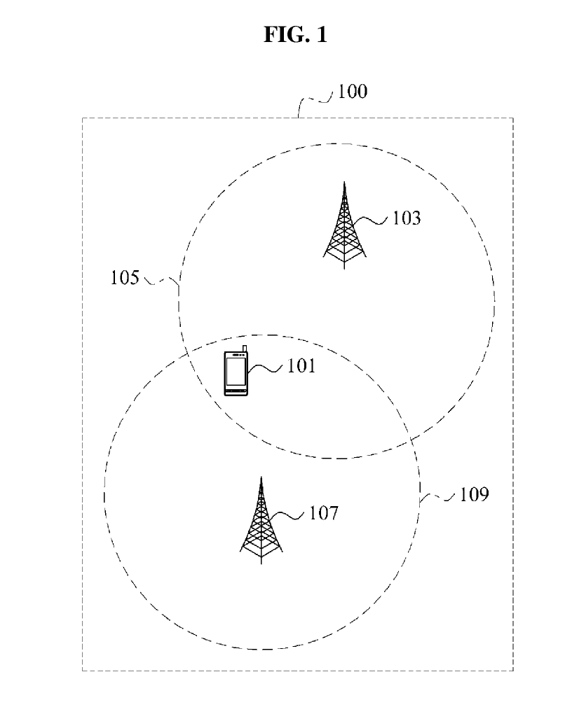

FIG. 1 is a diagram illustrating a system to support multiple interfaces using a user motion according to an exemplary embodiment of the invention.

Referring to FIG. 1, the system 100 includes a terminal 101, a first base station 103, and a second base station 107.

The terminal 101 may search for a service network that supports a system mode associated with a recognized motion. In an example, the recognized motion may be based on a change in direction of movement or orientation of the terminal 101, such as, a case in which positions of an upper end and a lower end of the terminal 101 are switched. The terminal 101 may be registered in a service network in response to a service network registration request to a system. If the terminal 101 is determined to be registered in an identified service network, the terminal 101 may support an interface associated with a service provided in the respective service network. Although the recognized motion is described in reference to a change in direction of movement or orientation of the terminal 101, it is not limited thereto. Without limitation, the recognized motion may include rotation movement, displacement, reference motions or gestures, and the like.

The terminal 101 may search for the service network using a communication method or a communication service provider.

As an example, in a case where a system mode associated with the recognized motion corresponds to Global System for Mobile Communications (GSM), the terminal 101 may search for a service network 105 supporting the GSM and may display an interface associated with a service provided in the service network 105 if the terminal 101 is registered in the service network 105. The terminal 101 may register in the service network 105 by transmitting a response signal to a service network registration request, which may be received at the first base station 103 associated with the service network 105.

Also, in a case where the system mode associated with the recognized motion corresponds to Code Division Multiple Access (CDMA), the terminal 101 may search for a service network 109 supporting the CDMA system mode and may display an interface associated with a service (e.g., navigation, internet) provided in the service network 109 if the terminal 101 is registered in the service network 109. The terminal 101 may register in the service network 105 by transmitting a response signal to a service network registration request, which may be received at the second base station 107 associated with the service network 109.

Further, if multiple service networks are identified in a system mode of an identical or similar communication method, the terminal 101 may distinguish one or more applicable service networks by identifying a communication service provider in the respective system mode. For example, if more than one service network supporting the CDMA is recognized, the terminal 101 may identify a communication service provider ‘AA Telecom’ associated with a corresponding service, and may display an interface dedicated and specialized for ‘AA Telecom.’ That is, the terminal 101 may be registered in a service network supported by an identified communication service provider, and may display an identified interface associated with a service provided by the communication service provider.

Further, the terminal 101 may support the interface based on at least one of a Mobile Country Code (MCC) and a Mobile Network Code (MNC) for the service network in which the terminal 101 is registered, thereby providing an icon for a valid service. Also, the terminal 101 may deactivate a search for a band that is not supported in the service network based on at least one of the MCC and the MNC, thereby reducing an amount of time used for a network search if using a service.

If a fixed input is received or if no recognized motion is received for a reference period of time, the terminal 101 may restrict the motion recognition operation to maintain the system mode associated with the previously recognized motion. Accordingly, the interface may be hindered from being changed in accordance with an unintended system mode change.

The first base station 103 and the second base station 107 may provide different services to the terminal 101, which may be registered in the associated service network 105 and the associated service network 109, respectively. For example, the first base station 103 may control the associated service network 105 to support a GSM system mode, and the second base station 107 may control the associated service network 109 to support a CDMA system mode.

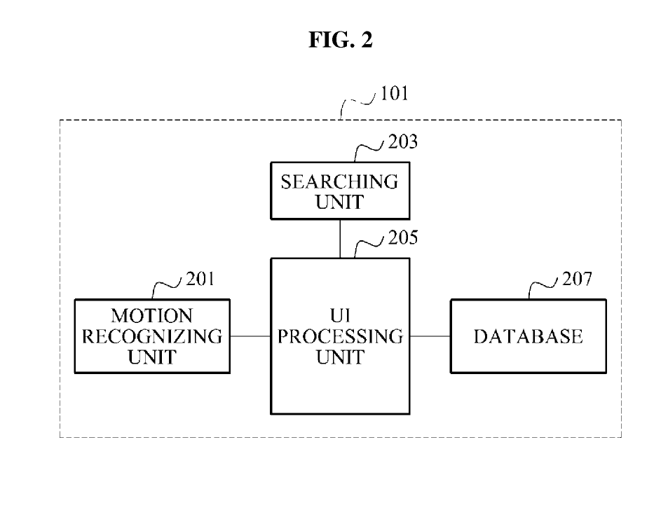

FIG. 2 is a block diagram illustrating a terminal to support multiple interfaces using a user motion according to an exemplary embodiment of the invention.

Referring to FIG. 2, the terminal 101 includes a motion recognizing unit 201, a searching unit 203, a user interface (UI) processing unit 205, and a database 207.

The motion recognizing unit 201 may detect a recognized motion and may support a service mode associated with the recognized motion. That is, the motion recognizing unit 201 may determine whether automatic motion recognition is set, and may detect a recognized motion based on a change in direction of movement or orientation of the terminal 101 if the automatic motion recognition is set. In an example, the motion recognizing unit 201 may detect the recognized motion if positions of an upper end and a lower end of a housing of the terminal 101 are switched. The recognized motion may refer to a movement of the terminal 101 itself according to a change in direction of movement or change in orientation, or may refer to a reference motion corresponding to a system mode.

The motion recognizing unit 201 may display, on a display unit, an external shape that may include an internal shape that may move according to the movement of the terminal 101. The external shape may correspond to, for example, a triangle, and the internal shape may correspond to, for example, a circle. If the internal shape is displayed to touch a first side of the external shape, the motion recognizing unit 201 may detect the corresponding movement of the terminal 101 as a first motion. If the internal shape is displayed to be away from the first side of the external shape or if the internal shape is displayed to touch a second side of the external shape, the motion recognizing unit 201 may detect that the corresponding movement of the terminal 101 as a second motion. Accordingly, if a position of the terminal 101, which corresponds to the internal shape touching the first side of the external shape, moves to a different position, which corresponds to the internal shape touching the second side of the external shape, the terminal 101 may be determined to have changed from the first motion to the second motion.

In a case where a reference point on the display unit is moved from a first position having first coordinates to a second position having second coordinates in accordance with the change in direction or orientation of the terminal 101, the motion recognizing unit 201 may detect the recognized motion based on the change in direction or orientation of the terminal 101 if an angle between an imaginary line passing through the first coordinates and an imaginary line passing through the second coordinates is greater than or equal to a reference angle.

The searching unit 203 may search for a service network associated with the recognized motion. That is, the searching unit 203 may search for a service network supporting a system mode associated with the recognized motion. If the motion recognized by the motion recognizing unit 201 corresponds to a movement of the terminal 101 according to the change in direction of movement or orientation, the searching unit 203 may search for a service network supporting the system mode that may be different from a system mode stored in the database 207.

In the service network search, the searching unit 203 may perform the search for the service network in view of a communication method or a communication service provider. If the recognized motion corresponds to a movement of the terminal 101 according to a change in direction of movement or orientation, and the stored system mode corresponds to a GSM, the searching unit 203 may search for a service network supporting a CDMA system mode that is different from the GSM system mode.

If the motion recognized by the motion recognizing unit 201 corresponds to a reference motion, which may correspond to a system mode desired to be set, the searching unit 203 may search for a service network that supports a system mode corresponding to the reference motion.

If a first motion is recognized, the searching unit 203 may search for a service network supporting a first system mode, in which the system mode may include at least one of a GSM, a Wavelength Code Division Multiple Access (WCDMA), and a Long Term Evolution (LTE). Further, the searching unit 203 may search for a first service provider communication. If a second motion is recognized, the searching unit 203 may search for a service network supporting a second system mode, which may include at least one of a CDMA and a WCDMA. Further, the searching unit 203 may search for a second service provider communication. The second system mode associated with the second motion may be different from the first system mode.

For example, if the recognized motion corresponds to the GSM, the searching unit 203 may search for a service network supporting a GSM system mode. If the recognized motion corresponds to the CDMA, the searching unit 203 may search for a service network supporting a CDMA system mode. Also, if the stored system mode corresponds to ‘a first service provider communication mode,’ the searching unit 203 may search for a service network supporting the first service provider communication. If the stored system mode corresponds to ‘a second service provider communication mode,’ the searching unit 203 may search for a service network supporting the second service provider communication, thereby preparing an environment in which a service of a communication method supported by a reference communication service provider may be provided.

If the motion recognizing unit 201 determines that the automatic motion recognition is not set, the searching unit 203 may search for a service network supporting a system mode that may be stored in the database 207. For example, if it is determined that the automatic motion recognition is not set and the stored system mode corresponds to the GSM, the searching unit 203 may search for a service network that supports the GSM system mode.

The UI processing unit 205 may change the interface associated with the service network if the service network is changed to the service network found by the searching unit 203. That is, if the terminal 101 is registered in the found service network, the UI processing unit 205 may support interfaces associated with a service provided in the service network, which may include, communication setting, menu types, arrangement, and the like. If the terminal 101 is registered in a service network supporting a GSM system mode, the UI processing unit 205 may provide a video share service as part of an Internet Protocol service.

Further, the UI processing unit 205 may identify a communication service provider based on at least one of an MCC and an MNC, and may support an interface corresponding to the identified communication service provider. Here, the UI processing unit 205 may identify a service corresponding to the communication service provider in the database 207, and may display an interface associated with the service. The database 207 may classify and store interfaces associated with one or more services.

The UI processing unit 205 may deactivate a search for a band that may not be supported by the service network based on at least one of the MCC and the MNC, thereby possibly reducing an amount of time used for a network search and/or reducing battery consumption if using the service.

If the terminal 101 is determined to be registered in a service network provided by a roaming service provider, the UI processing unit 205 may provide a basic service by parsing common operations and setting information that may be defined in a terminal, including general packet radio service (GPRS) settings, web settings, and a short message service center (SMSC) address.

If the terminal 101 is determined to be registered in a service network, the UI processing unit 205 may store, in the database 207, a system mode supported in the service network. If the terminal 101 is determined to be registered in the service network, the UI processing unit 205 may receive a selective input regarding whether the recognized motion is fixed. If a fixed input regarding the motion is received as the selective input, the UI processing unit 205 may cancel a setting for the automatic motion recognition, and may restrict the motion recognition, thereby maintaining a system mode associated with the recognized motion, and preventing the interface from being changed by an unintended system mode change. If the terminal 101 is determined to be registered in a service network supporting a GSM system mode and the fixed input regarding the motion is received, the UI processing unit 205 may restrict motion recognition, thereby maintaining the GSM system mode associated with the recognized motion.

If the terminal 101 is determined not to be registered in the service network, the UI processing unit 205 may perform another search for a service network based on a change in position, orientation or direction of terminal 101 by prompting a user to change the position, orientation or direction of the terminal 101, by displaying a message for requesting such action.

The database 207 may store information about at least one of a current system mode and services for the one or more system modes. In an example, a common service, a reference service corresponding to a communication service provider, and an application service downloaded by a user may be stored. Various stored services corresponding to a particular system mode may be provided if the respective system mode is activated.

The terminal 101 may include a speaker or a microphone to receive an input of data associated with a service or output the data associated with the service corresponding to a system mode if the respective system mode is activated. For example, the terminal 101 may include a first speaker and a first microphone to be activated in the first system mode, and may include a second speaker and a second microphone to be activated in the second system mode.

Further, positions of the first speaker and the first microphone may be at positions opposite of the second speaker and the second microphone. For example, if the first speaker and the first microphone are disposed on an upper end of the terminal 101, the second speaker and the second microphone may be disposed on a lower end of the terminal 101.

According to exemplary embodiments of the invention, a terminal to support multiple interfaces using a recognized motion may provide an interface associated with a service, which may be provided by a corresponding communication service provider. After selecting a system mode based on a motion and initiating the service, of the likelihood of an error occurring if a user selects a service that is not provided by the current communication service provider may be reduced. Accordingly, the terminal may reduce the likelihood of error if a user unfamiliar with technical knowledge is requested to select a system mode. Further, the likelihood of an error associated with selecting an interfaces corresponding to a service that is not provided by a current communication service provider may be reduced.

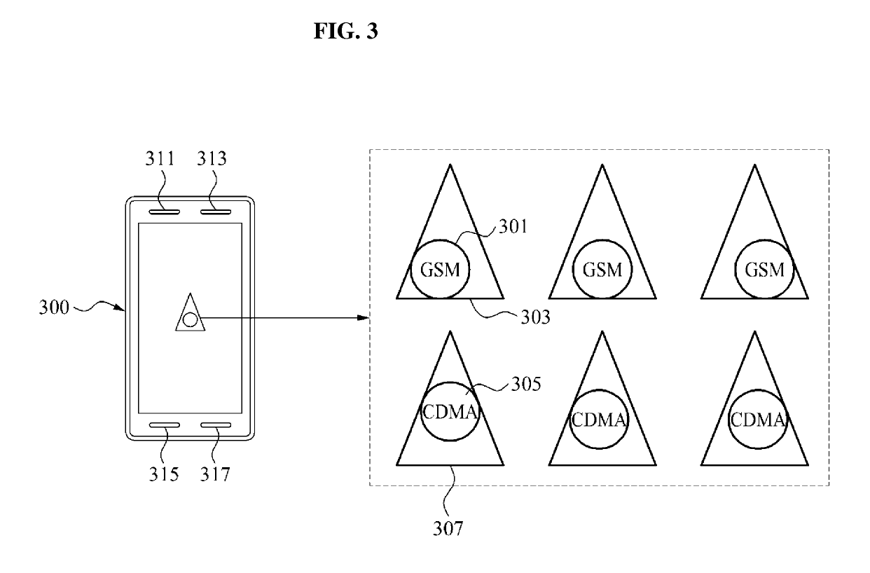

FIG. 3 is a diagram illustrating a method for recognizing a motion in a terminal to support multiple interfaces using a user motion according to an exemplary embodiment of the invention.

Referring to FIG. 3, a terminal 300 may display, on a display unit, an external shape that may include an internal shape that may move according to a movement of the terminal 300. More specifically, the internal shape may correspond to a changed orientation or position of the terminal 300, and the external shape may correspond to a reference orientation or position of the terminal 300. If the internal shape touches a first side of the external shape, the movement of the terminal 300 may be recognized as a first motion. If the internal shape is displayed to be away from the first side of the external shape or if the internal shape is displayed to touch a second side of the external shape, the corresponding movement of the terminal 300 may be recognized as a second motion. Accordingly, if a position of the terminal 300, which corresponds to the internal shape touching the first side of the external shape, moves to a different position, which corresponds to the internal shape touching the second side of the external shape, the terminal 300 may be determined to have changed from the first motion to the second motion.

As shown in FIG. 3, the terminal 300 may display, on the display unit, a triangle including a circle 301 that may move according to a change in direction of movement or orientation. If the circle 301 is displayed to touch a first side of the triangle, that is, a bottom side 303, a motion may be recognized as a first motion, which may be a motion associated with a GSM system mode. If the circle 301 is displayed to be away from the bottom side 303 or if the circle 301 is displayed to touch a second side of the triangle, that is, one of the other two sides, a motion may be recognized as a second motion, which may be a motion associated with a CDMA system mode. Accordingly, if a position of the terminal 300, which corresponds to the circle 301 touching the first side of the triangle, moves to a different position, which corresponds to the circle 301 touching the second side of the triangle, it may be determined that the motion is changed from the first motion to the second motion.

The terminal 300 may include a speaker or a microphone for one or more system modes. For example, the terminal 300 may include a first speaker 311 and a first microphone 313 to be activated in the first system mode, which may be the system mode associated with the GSM. The terminal 300 may include a second microphone 315 and a second speaker 317 to be activated in the second system mode, which may be the system mode associated with the CDMA.

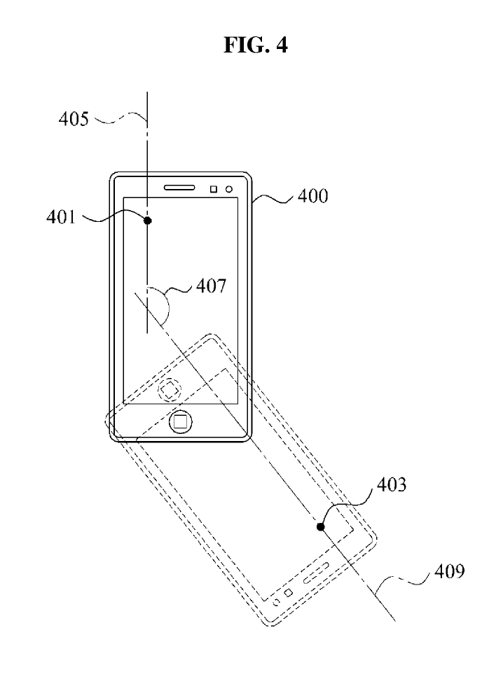

FIG. 4 is a diagram illustrating a method for recognizing a motion in a terminal supporting multiple interfaces using a user motion according to an exemplary embodiment of the invention.

Referring to FIG. 4, a terminal 400 may recognize a motion based on a change in direction. The change in direction may be determined using reference coordinates that may be varied according to the change in direction.

As shown in FIG. 4, a reference point on a display unit is moved from a first location having coordinates 401 to a second location having coordinates 403 in accordance with a change in direction of the terminal 400. The terminal 400 may recognize a motion according to the change in direction if an angle between an extended line 405 passing through the first coordinates 401 and an extended line 409 passing through the second coordinates 403 is greater than or equal to a reference angle 407.

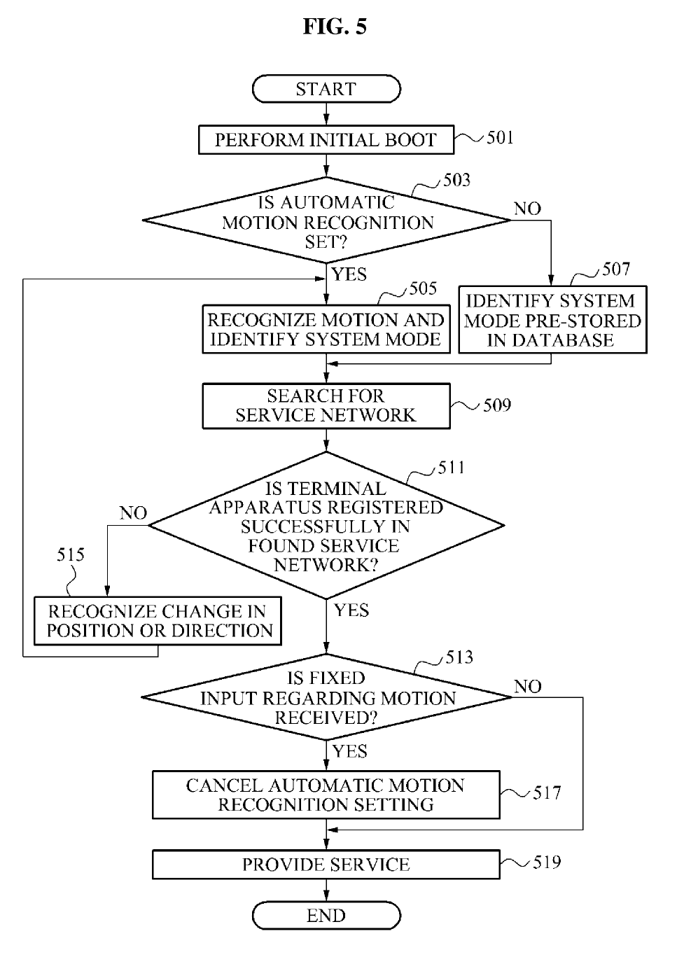

FIG. 5 is a flowchart illustrating a method for supporting multiple interfaces using a user motion according to an exemplary embodiment of the invention.

Referring to FIG. 5, in operation 501, a terminal may perform initial boot. In operation 503, the terminal may determine whether automatic motion recognition is set.

If the automatic motion recognition is determined to be set, the terminal may recognize a reference motion based on a movement of the terminal, which may include a change in direction, rotation, displacement and the like. Further, the terminal may identify a system mode associated with the recognized motion, in operation 505. That is, the terminal may search for a service network supporting the system mode associated with the recognized motion.

The terminal may search for the service network in view of a communication method or a communication service provider. For example, the terminal may search for a service network supporting a GSM or a CDMA. In addition, the terminal may search for a service network by identifying a communication service provider, if more than one service providers are identified in an identical communication method.

The terminal may recognize the motion if positions of an upper end and a lower end of a housing of the terminal are switched. Here, the motion may refer to a movement itself according to a change in direction, or may refer to a reference motion corresponding to a system mode desired to be set.

As an example, the terminal may display, on a display unit, an external shape including an internal shape that may move according to the change in direction of movement or orientation of the terminal. Here, the external shape may correspond to, for example, a triangle, and the internal shape may correspond to, for example, a circle. If the internal shape is displayed to touch a first side of the external shape, the terminal may detect the as corresponding movement of the terminal as a first motion. If the internal shape is displayed to be away from the first side of the external shape or if the internal shape is displayed to touch a second side of the external shape, the terminal may detect that the corresponding movement of the terminal as a second motion. Accordingly, if a position of the terminal, which corresponds to the internal shape touching the first side of the external shape, moves to a different position, which corresponds to the internal shape touching the second side of the external shape, the terminal may be determined to have changed from the first motion to the second motion.

Further, in a case where a reference point on the display unit is moved from a first location having first coordinates to a second location having second coordinates in accordance with the change in movement of the terminal, the terminal may recognize the movement as a reference motion if an angle between an imaginary line passing through the first coordinates and an imaginary line passing through the second coordinates is greater than or equal to a reference angle.

If the automatic motion recognition is not set, the terminal may identify a system mode that may be stored in the database as a system mode to be set, in operation 507. For example, if it is determined that the automatic motion recognition is not set and the stored system mode corresponds to a GSM system mode, the terminal may identify the GSM system mode as the system mode to be set.

In operation 509, the terminal may search for a service network supporting the identified system mode.

If the recognized motion corresponds to a reference motion corresponding to a system mode desired to be set, the terminal may search for a service network supporting a system mode corresponding to the reference motion. For example, if the recognized motion corresponds to a GSM system mode, the terminal may search for a service network supporting the GSM system mode. If the recognized motion corresponds to a CDMA system mode, the terminal may search for a service network supporting the CDMA system mode. Also, if a stored system mode corresponds to ‘a first service provider communication mode,’ the terminal may search for a service network supporting the first service provider communication. If the stored system mode corresponds to ‘a second service provider communication mode,’ the terminal may search for a service network supporting the second service provider communication.

If the movement of the terminal corresponds to a recognized motion, the terminal may search for a service network supporting a system mode corresponding to the recognized motion, rather than the system mode stored in the database. For example, if the movement of the terminal corresponds to a recognized motion for a CDMA system mode, and the stored system mode corresponds to the GSM system mode, the terminal may search for a service network supporting the CDMA system mode. In the same example, if no recognized motion is detected by the terminal, the terminal may search for a service network supporting the GSM system mode.

The terminal may be registered in the found service network if a service network registration request to a system associated with the found service network is accepted.

In operation 511, the terminal may determine whether the terminal is registered successfully in the service network. In a case where the terminal is determined not to be registered in the service network, the terminal may return to the operation 505 to perform another search for a service network. The secondary search for the service network may be performed in response to recognizing a change in a position or a direction of the terminal. The change in position or direction of the terminal may be induced by displaying a message for requesting to change the position or direction, in operation 515.

If the terminal is registered in the service network, the terminal may determine whether a fixed input regarding the motion is received, in operation 513.

If the fixed input regarding the motion is received, the terminal may cancel the setting for the automatic motion recognition to restrict the motion recognition based on the change in direction, in operation 517, thereby maintaining the system mode associated with the recognized motion. Accordingly, the terminal may reduce a likelihood of an interface from being changed in accordance with an unintended system mode change. For example, if the terminal is registered in a service network supporting the GSM system mode, and the fixed position input is received, the terminal may restrict the motion recognition to maintain the GSM system mode associated with the previously recognized motion. Also, if the fixed input regarding the motion is not received in operation 513, the setting for the automatic motion recognition may be maintained.

In operation 519, the terminal may provide service by supporting an interface associated with the service provided in the service network. If the terminal is registered in the found service network, the terminal may support an interface associated with the service provided in the service network.

In supporting the interface associated with the service, the terminal may additionally display an interface associated with an activated service on a display of the terminal.

In this instance, the terminal may change and display the interface by mapping the interface associated with the activated service based on a category of an interface associated with a deactivated service, that is, an interface corresponding to an unavailable service.

Also, the terminal may remove an interface associated with other deactivated services from the display of the terminal.

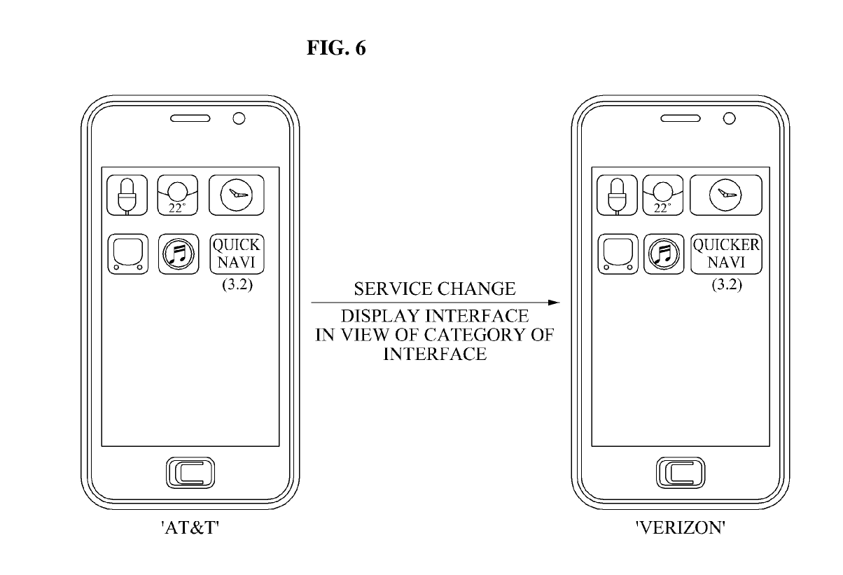

FIG. 6 is a diagram illustrating an interface being replaced in accordance with a service change according to an exemplary embodiment of the invention.

Referring to FIG. 6, a service may be changed from a GSM system mode to a CDMA system mode. During this service change, an interface “Quick Navi” may be used in the GSM, for example, AT&T system mode, and a different interface “Quicker Navi” may be used in the CDMA, for example, Verizon system mode.

The interface “Quicker Navi”, which corresponds to the CDMA system mode, may be newly activated according to the service change from the GSM system mode to the CDMA system mode, and the interface “Quick Navi” may be deactivated according to the service change. A terminal may identify a category of the two interfaces as ‘navigation,’ and may replace the interface “Quick Navi” with the interface “Quicker Navi”, which may be displayed on a display of the interface “Quick Navi” that may disappear according to the service change.

In FIG. 6, the terminal may replace the interface “Quick Navi” corresponding to the GSM system mode with the interface “Quicker Navi” of the CDMA system mode to be newly activated. In addition, the terminal may display the interface “Quicker Navi” in the same position where the interface “Quick Navi” may be located.

In a manner described in the foregoing, a user may use an interface with less likelihood of confusion about the service change.

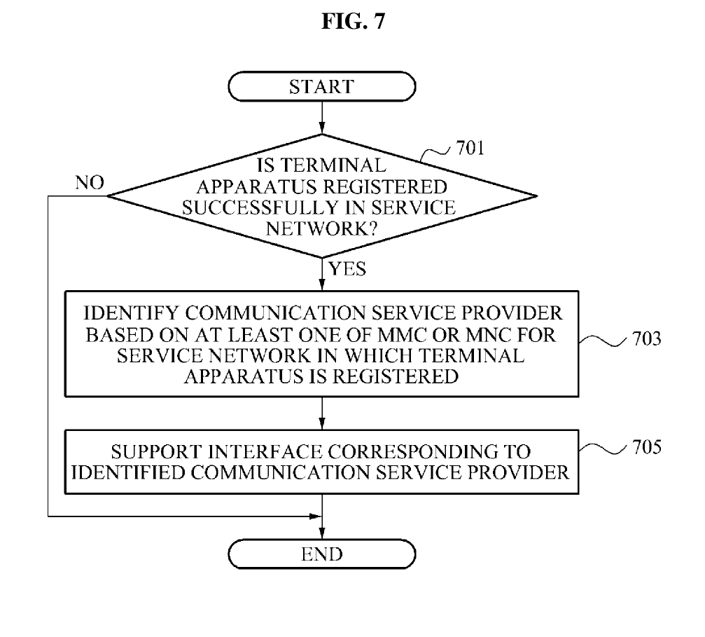

FIG. 7 is a flowchart illustrating a method for supporting multiple interfaces using a user motion according to an exemplary embodiment of the invention.

Referring to FIG. 7, in operation 701, a terminal may perform initial boot, and may determine whether the terminal is registered successfully in a service network.

If the terminal is determined to be registered in the service network, the terminal may identify a communication service provider based on at least one of an MCC or an MNC for the service network in which the terminal is registered, in operation 703.

The terminal may deactivate a search for a band that is not supported in the service network based on at least one of the MCC or the MNC. Accordingly, time used searching for a network and/or battery consumption of the terminal may be reduced.

In operation 705, the terminal may support an interface corresponding to the identified communication service provider. That is, the terminal may display a service interface corresponding to a communication service provider, a common interface, and an interface associated with an application service downloaded by a user, such as, communication setting, menu types, arrangement, and the like.

According to exemplary embodiments of the invention, it may be possible to register a terminal in a service network supporting a system mode associated with a recognized motion, and support an interface associated with a service provided in the service network in which the terminal is registered. Accordingly, a system mode may be changed to support an interface associated with a service provided in association with the change.

According to exemplary embodiments of the invention, it may be possible to deactivate a search for a band that is not supported in a service network in which a mobile apparatus is registered, based on at least one of an MCC and an MNC for the service network. Accordingly, amount of time used for a network search and battery consumption of the terminal may be reduced.

The exemplary embodiments according to the invention may be recorded in computer-readable media including program instructions to implement various operations embodied by a computer. The media may also include, alone or in combination with the program instructions, data files, data structures, and the like. The media and program instructions may be those specially designed and constructed for the purposes of the exemplary embodiments of the invention, or they may be of the kind well-known and available to those having skill in the computer software arts. Examples of computer-readable media include magnetic media such as hard disks, floppy disks, and magnetic tape; optical media such as CD ROM discs and DVD; magneto-optical media such as floptical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the invention.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

1. A method for providing an interface corresponding to a system mode, comprising:
detecting a first motion of a terminal;
determining whether the first motion is a recognized motion;
identifying the system mode corresponding to the recognized motion;
searching for a service network supporting the system mode;
storing, in a database, interfaces associated with each service; and
providing the interface corresponding to the system mode.

2. The method of claim 1, further comprising:
determining whether an automatic motion recognition is set; and
identifying a default system mode if the automatic motion recognition is determined not to be set.

3. The method of claim 1, further comprising:
determining whether the terminal is registered in the service network; and
detecting a second motion of the terminal, if it is determined that the terminal is not registered.

4. The method of claim 3, further comprising:
identifying a communication service provider corresponding to the service network based on at least one of a Mobile Country Code (MMC) and a Mobile Network Code (MNC).

5. The method of claim 2, further comprising:
determining whether a fixed input associated with the recognized motion is received; and
cancelling automatic recognition setting if the fixed input is received.

6. The method of claim 1, wherein the recognized motion comprises at least one of a change in a direction of movement and change in orientation of the terminal.

7. The method of claim 1, further comprising:
identifying a default system mode stored in the terminal, wherein the default system mode is searched for if the recognized motion is not received.

8. The method of claim 1, wherein the system mode comprises at least one of Global System for Mobile Communications (GSM), a Code Division Multiple Access (CDMA), a Wavelength Code Division Multiple Access (WCDMA), and a Long Term Evolution (LTE).

9. The method of claim 1, further comprising:
deactivating a search for a band not supported by the service network based on at least one of the MCC and MNC.

10. A terminal to provide an interface corresponding to a system mode, comprising:
a motion recognizing unit to detect a first motion of the terminal, to determine whether the first motion is a recognized motion, and to identify a system mode corresponding to the recognized motion;
a searching unit to identify a service network supporting the system mode;
a database to classify and store interfaces associated with each service; and
a user interface (UI) processing unit to provide an interface that corresponds to the system mode.

11. The terminal of claim 10, wherein the motion recognizing unit further determines whether automatic motion recognition is set.

12. The terminal of claim 10, further comprising:
a display unit to display an external shape comprising an internal shape, wherein the external shape corresponds to a reference orientation of the terminal, and the internal shape corresponds to the first motion of the terminal.

13. The terminal of claim 10, wherein the recognized motion comprises at least one of a change in direction and a change in orientation of the terminal.

14. The terminal of claim 10, wherein a service network supporting the system mode comprises at least one of Global System for Mobile Communications (GSM), a Code Division Multiple Access (CDMA), a Wavelength Code Division Multiple Access (WCDMA), and a Long Term Evolution (LTE).

15. The terminal of claim 10, wherein if the motion recognizing unit determines that the automatic motion recognition is not set, the searching unit searches for a service network that supports a default system mode stored in the database.

16. The terminal of claim 10, wherein the UI processing unit identifies a communication service provider based on at least one of a Mobile Country Code (MCC) and a Mobile Network Code (MNC).

17. The terminal of claim 10, wherein the UI processing unit deactivates a search to identify a band that is not supported by the service network based on at least one of the MCC and the MNC.

18. The terminal of claim 11, wherein the UI processing unit cancels automatic motion recognition setting if a fixed input associated with the recognized motion is received.

19. The terminal of claim 10, wherein if the terminal is determined not to be registered in the service network, the terminal prompts to receive a second motion.

20. A method for providing an interface corresponding to a system mode, comprising:
detecting a first position of a terminal;
detecting a second position of a terminal;
determining whether a movement of the terminal from the first position to the second position is a recognized motion;
identifying the system mode corresponding to the recognized motion;
searching for a service network supporting the system mode; and
providing the interface corresponding to the system mode,
wherein the movement of the terminal is determined to be the recognized motion if an angle formed between the first position and the second position is at least a reference angle.
